(19) United States
(12) Patent Application Publication
(10) Pub. No.: US 2019/0286251 A1
(43) Pub. Date: Sep. 19, 2019

(54) SENSING SYSTEM FOR NUMERICAL REPRESENTATION

(71) Applicant: Gasser ABOUBAKR, Tracy, CA (US)

(72) Inventor: Gasser ABOUBAKR, Tracy, CA (US)

(21) Appl. No.: 16/301,918

(22) PCT Filed: May 12, 2017
(86) PCT No.: PCT/US17/00033

§ 371 Date: Nov. 15, 2018

Related U.S. Application Data
(60) Provisional application No. 62/336,752, filed on May 16, 2016.

(51) Int. Cl. G06F 3/03; G06F 3/02

(52) U.S. Cl. CPC G06F 3/0325; G06F 3/0219

(57) ABSTRACT

A sensing system for numerical representation is disclosed. The sensing system is comprised of optical sensors each of which provides output signal, a bar to hold the optical sensor, sliding objects to be slide over the bar to intersect with optical wave of the optical sensors; and a microprocessor to receive the output signals of the optical sensors and converts each unique combination of the output signals into an identifier representing a number.

### PRIORITY

This application claims the benefit of priority based upon U.S. Provisional Patent Application Ser. No. 62/336,752, filed on date May 16, 2016 and entitled “Sensing System for Numerical Representation,” which is hereby incorporated herein by reference in its entirety.

### TECHNICAL FIELD

The exemplary embodiment(s) of the present invention relates to the field of numerical input for digital devices. More specifically, the exemplary embodiment(s) of the present invention relates to a sensing system for numerical representation.

### BACKGROUND

Providing numerical input to digital device is an essential to the user's interaction with various digital devices. This includes computer keyboards, mobile phone keyboards, or calculator keyboards. In such cases, there is a button on the keyboard associated with one numeral from 0 to 10. Until now there is no input device that allows the user to utilize more than one button or object to provide one the ten numerals.

Utilizing more than one object to provide one of the ten numeral can be utilized for various learning, training, or educational purposes especially with students or young kids.

### SUMMARY

In one embodiment, the present invention is comprised of a sensing system for numerical representation is disclosed. The sensing system is comprised of: optical sensors each of which generate optical wave to provide output signal when the path of the optical wave is intersected with an object; a bar to contain the optical sensors beside each other; sliding objects each of which can be slide over the bar to make an optical sensor provides an output signal when the sliding object intersects with the path of the optical wave of the optical sensor; and a microprocessor to receive the output signals of the optical sensors and converts each unique combination of the output signals into an identifier representing a number.

In another embodiment, the present invention is comprised of a sensing system for numerical representation is disclosed. The sensing system is comprised of: a plurality of bars positioned in a container wherein each one of the plurality of bars is connected with; a plurality of optical sensors each of which generates optical wave to provide output signal when the path of the optical wave is intersected with an object; and sliding objects each of which can be slide over the bar to make an optical sensor provides an output signal when the sliding object intersects with the path of the optical wave of the optical sensor; and a microprocessor to receive the output signals of the optical sensors and converts each unique combination of the output signals into an identifier representing a number.

Additional features and benefits of the present invention will become apparent from the detailed description, figures and claims set forth below.

### BRIEF DESCRIPTION OF DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a cross-section of a sensing device showing the main component of the present invention according to one embodiment.

FIG. 2 illustrates the front view of the sensing device of the present invention according to one embodiment.

FIG. 3 illustrates the top view of the sensing device of the present invention according to one embodiment.

FIG. 4 illustrates an isometric view of the sensing device of the present invention according to one embodiment.

### DETAILED DESCRIPTION

Those of ordinary skilled in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the exemplary embodiments of the present invention as illustrated in the accompanying drawings.

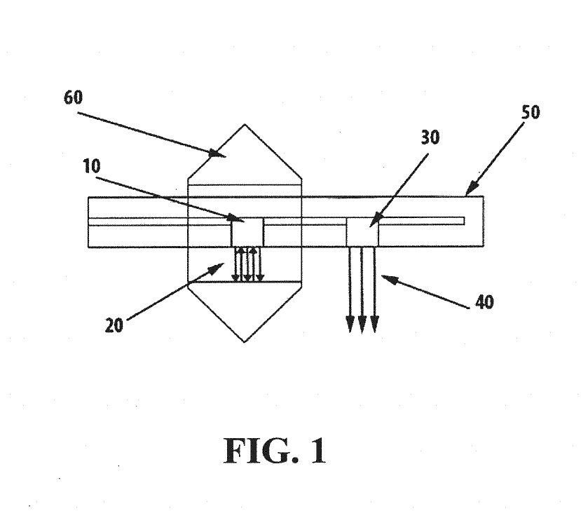

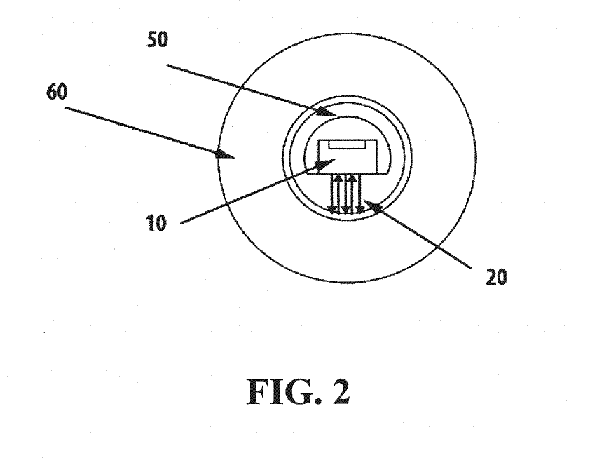

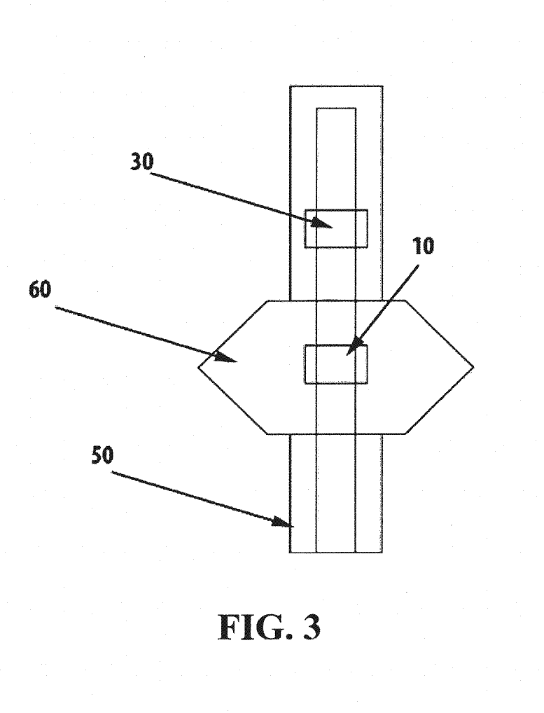

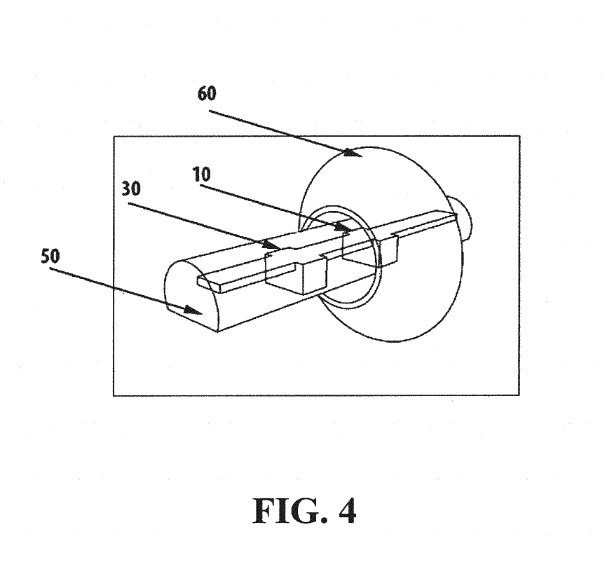

FIG. 1 illustrates the present invention according to one embodiment. As shown in the figure, the present invention is comprised of a first optical sensor 10 and a second optical sensor 30 positioned on bar 50, and a bead 60 with a hole to be slide over the bar. The arrows 20 of the figure represent optical wave reflected back to the optical sensor when the bead intersects with its path. The arrows 40 of the figure represent optical wave that is not reflected by the bead or any other object. Once the optical wave is reflected the optical sensor provides an output signal representing the reflection of the optical wave. FIGS. 2-4 illustrate different views of the present invention.

The two optical sensors are connected with a microprocessor to receive the output signal and convert each combination of the output signal into an identifier representing a numeral. For example, the output signal of the two optical sensors can represent one of four options. These four options can be used to provide a computer system with four different inputs representing four numbers from 1 to 4.

Increasing the number of the optical sensors and the number of the beads on the same bar can provide more input combination to the microprocessor. For example, when the number of optical sensors is seven and the number of beads is five, then the combination of the positions of the five beads can represent a numeral from 0 to 9. Increasing the number of the bars allows providing any numbers comprised of multiple digits. For example, using eight bars allows the user to provide a number comprised of eight digits.

The output of the microprocessor can be provided to various electronic devices equipped with a digital display such as a computer, calculator, tablet, or mobile phone.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

1. A sensing system for numerical representation comprising;
optical sensors each of which generate an optical wave to provide an output signal when a path of the optical wave is intersected with an object;
a bar to contain the optical sensors beside each other;
sliding objects each of which can slide over the bar to make an optical sensor provide an output signal when the sliding object intersects with the path of the optical wave of the optical sensor; and
a microprocessor to receive the output signals of the optical sensors and converts each unique combination of the output signals into an identifier representing a number.

2. The sensing system of claim 1, wherein each one of the optical sensors is comprised of a first part that emits the optical wave and a second part that receives the optical wave.

3. The sensing system of claim 1, wherein the optical wave is infra-red.

4. The sensing system of claim 1, wherein the optical wave is a visible light.

5. The sensing system of claim 1, wherein the output signal is an analog signal.

6. The sensing system of claim 1, wherein the output signal is a digital signal.

7. The sensing system of claim 1, wherein each one of the sliding objects is a bead with a hole in the center to slide over the bar.

8. The sensing system of claim 1, wherein the intersect with the path means blocks the optical wave.

9. The sensing system of claim 1, wherein the intersect with the path means reflects the optical wave.

10. The sensing system of claim 1, wherein the each unique combination is a combination of analog signals each of which associated with a position of one of the optical sensors.

11. The sensing system of claim 1, wherein the each unique combination is a combination of digital signals each of which associated with a position of one of the optical sensors.

12. The sensing system of claim 1, wherein the identifier is provided to a computer system.

13. The sensing system of claim 1, wherein the identifier is provided to a digital display.

14. A sensing system for numerical representation comprising;
a plurality of bars positioned in a container wherein each one of the plurality of bars is connected with;
a plurality of optical sensors each of which generates an optical wave to provide an output signal when a path of the optical wave is intersected with an object; and
sliding objects each of which can slide over the bar to make an optical sensor provide an output signal when the sliding object intersects with the path of the optical wave of the optical sensor; and
a microprocessor to receive the output signals of the optical sensors and converts each unique combination of the output signals into an identifier representing a number.

15. The sensing system of claim 14, wherein each one of the optical sensors is comprised of a first part that emits the optical wave and a second part that receives the optical wave.

16. The sensing system of claim 14, wherein the optical wave is infra-red.

17. The sensing system of claim 14, wherein the optical wave is a visible light.

18. The sensing system of claim 14, wherein the output signal is an analog signal.

19. The sensing system of claim 14, wherein the output signal is a digital signal.

20. The sensing system of claim 14, wherein each one of the sliding objects is a bead with a hole in the center to slide over the bar.

21. The sensing system of claim 14, wherein the intersect with the path means blocks the optical wave.

22. The sensing system of claim 14, wherein the intersect with the path means reflects the optical wave.

23. The sensing system of claim 14, wherein the each unique combination is a combination of analog signals each of which associated with a position of one of the optical sensors.

24. The sensing system of claim 14, wherein the each unique combination is a combination of digital signals each of which associated with a position of one of the optical sensors.

25. The sensing system of claim 14, wherein the identifier is provided to a computer system.

26. The sensing system of claim 14, wherein the identifier is provided to a digital display.
